(19) United States
(12) Patent Application Publication
(10) Pub. No.: US 2006/0098956 A1
(43) Pub. Date: May 11, 2006

(54) AUDIO/VIDEO PLAYER, DATA PROCESSING CIRCUIT THEREOF, DATA PROCESSING METHOD THEREOF, AND DATA DISTRIBUTING METHOD

(76) Inventors: Chia-Chin Wang, Taipei City (TW); Yung-Chieh Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/904,218

(22) Filed: Oct. 29, 2004

(51) Int. Cl. H04N 5/781

(52) U.S. Cl. 386/125; 386/126

(57) ABSTRACT

An audio/video player includes a decoder and a data processing circuit. The decoder is capable of decoding data outputted from an optical storage device through a communication protocol. The data processing circuit includes a first interface electrically coupled to a network system for receiving an encoded audio/video data from the network system, and a second interface electrically coupled to the decoder and the first interface. The second interface emulates operations of the optical storage device and transmits the encoded audio/video data to the decoder through the communication protocol.

### BACKGROUND OF THE INVENTION

1. Field of the Invention

The present invention relates to distributing multimedia content through a network system, and more particularly, to an audio/video player, a data processing circuit thereof, a data processing method thereof, and a data distributing method.

2. Description of the Prior Art

When a service provider distributes multimedia content such as movies and music programs to end users through a network system, each of the end users needs a receiving end device such as a personal computer for receiving and playing the multimedia content provided by the service provider. Another way for distributing multimedia content is transmitting audio and video information using terrestrial or satellite radio broadcasting technologies. In these examples, each of the end users has to prepare a receiving end device in advance so as to take advantage of the service to be provided by a service provider, no matter whether the service is fine or poor.

One similar application for distributing multimedia content is PDP/LCD-based advertising, which utilizes receiving end devices to receive multimedia sent from a server through a network system. If each receiving end device needs to be a computer or a customized product specializing in this application, it is very expensive to setup the whole advertising system. Therefore, it is important and necessary to reduce the installation cost of the receiving end devices for distributing multimedia content through a network system.

### SUMMARY OF THE INVENTION

It is therefore an objective of the present invention to provide an audio/video player, a data processing circuit thereof, a data processing method thereof, and a data distributing method.

The present invention provides a data processing circuit of an audio/video player. The audio/video player includes a decoder capable of decoding data outputted from an optical storage device through a communication protocol. The data processing circuit includes: a first interface electrically coupled to a network system for receiving an encoded audio/video data from the network system; and a second interface electrically coupled to the decoder and the first interface, the second interface emulating operations of the optical storage device and transmitting the encoded audio/video data to the decoder through the communication protocol.

The present invention further provides an audio/video player including a decoder and a data processing circuit. The decoder is capable of decoding data outputted from an optical storage device through a communication protocol. The data processing circuit includes: a first interface electrically coupled to a network system for receiving an encoded audio/video data from the network system; and a second interface electrically coupled to the decoder and the first interface, the second interface emulating operations of the optical storage device and transmitting the encoded audio/video data to the decoder through the communication protocol.

The present invention further provides a data processing method of an audio/video player. The audio/video player includes a decoder capable of decoding data outputted from an optical storage device through a communication protocol. The data processing method includes: receiving an encoded audio/video data from a network system; and providing an interface, and utilizing the interface for emulating operations of the optical storage device and for transmitting the encoded audio/video data to the decoder through the communication protocol.

The present invention further provides a data distributing method including: providing a first portion of an encoded audio/video data utilizing a first track; playing the first track to play the first portion; and replacing the first portion with another portion of the encoded audio/video data to provide the encoded audio/video data utilizing the first track, and playing the first track to play the encoded audio/video data.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a data distributing system for distributing multimedia content through a network system according to the present invention.

FIG. 2 is a diagram of the data processing circuit shown in FIG. 1.

### DETAILED DESCRIPTION

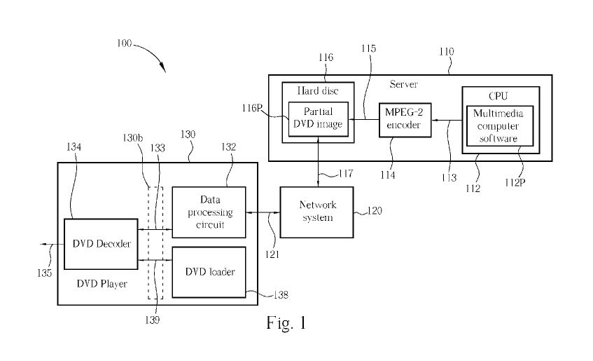

Please refer to FIG. 1, which illustrates a data distributing system 100 for distributing multimedia content through a network system 120 according to a first embodiment of the present invention. The data distributing system 100 includes a server 110, the network system 120 mentioned above, and at least an audio/video player such as an audio/video disc player. In this embodiment, the audio/video player is a DVD player 130. The server 110 includes a Central Processing Unit (CPU) 112 for executing multimedia computer software 112p, a MPEG-2 encoder 114 for encoding the multimedia content 113 generated by the CPU 112 to generate MPEG-2 encoded sequences 115, and a hard disc 116 for storing encoded audio/video data including the MPEG-2 encoded sequences mentioned above.

In this embodiment, the encoded audio/video data has a DVD data format and is referred to as the partial DVD image 116p as shown in FIG. 1. In one situation of this embodiment, the encoded audio/video data stored in the hard disc 116 can be generated by the server 110 according to the MPEG-2 encoded sequences 115 generated by the MPEG-2 encoder 114 and some other data such as headers and menu items complying with the DVD data format. As a result, the encoded audio/video data stored in the hard disc 116 looks like a portion of an image file of a DVD. In another situation of this embodiment, the encoded audio/video data stored in the hard disc 116 can also be generated by the server 110 according to content stored in a DVD accessed by a DVD drive (not shown) coupled to the server 110. In this situation, the encoded audio/video data includes at least a portion of an image file generated from the DVD. Therefore, according to either of the situations mentioned above, FIG. 1 illustrates the partial DVD image 116p to represent the encoded audio/video data.

As shown in FIG. 1, the DVD player 130 includes a bus 130b complying with a communication protocol. In this embodiment, the communication protocol is an ATAPI protocol. Besides, the DVD player 130 further includes a data processing circuit 132 coupled to the server 110 through the network system 120, a DVD decoder 134 coupled to the data processing circuit 132 through the bus 130b, and a DVD loader 138 coupled to the DVD decoder 134 through the bus 130b. The DVD loader 138 is used for loading a DVD to provide the DVD decoder 134 with data stored in the DVD. The DVD decoder 134 is capable of decoding data outputted from either the DVD loader 138 or the data processing circuit 132 through the ATAPI protocol. That is, the DVD player 130 is capable of playing either a DVD accessed by the DVD loader 138 or the partial DVD image 116p received by the data processing circuit 132 through the network system 120 while the data processing circuit 132 emulates another DVD loader coupled to the DVD decoder 134 through the bus 130b. The data processing circuit 132 is described in detail as follows.

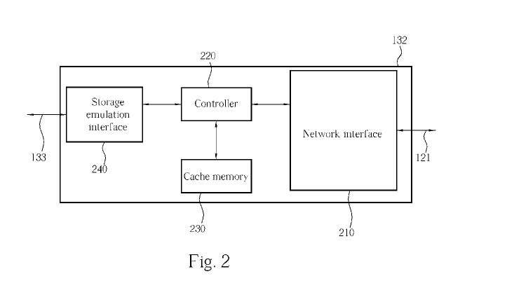

As shown in FIG. 2, the data processing circuit 132 includes a network interface 210 electrically coupled to the network system 120, a controller 220 electrically connected to the network interface 210, a cache memory 230 electrically connected to the controller 220, and a storage emulation interface 240 electrically connected to the DVD decoder 134 and the controller 230. In this embodiment, the network interface 210 is an Ethernet interface, which is commonly connected to the network system 120 using an RJ45 connector. The network interface 210 receives the encoded audio/video data 121 from the network system 120, wherein the encoded audio/video data 121 is derived from the partial DVD image 116p originally stored in the hard disc 116 of the server 110. In addition, the controller 220 is capable of controlling data flow between the network interface 210 and the storage emulation interface 240. Under the control of the controller 220, the cache memory 230 buffers the encoded audio/video data 121 to maintain the data flow mentioned above. In this embodiment, the storage emulation interface 240 emulates operations of a DVD loader and transmits the partial DVD image 116p to the DVD decoder 134 through the ATAPI protocol. As a result, the DVD player 130 is capable of accessing the partial DVD image 116p for playback.

As needed, a user would like to repeat a plurality of tracks listed in the menu item mentioned above. For this application, the partial DVD image 116p includes these tracks to be repeated. The DVD player 130 accesses the partial DVD image 116p through the data processing circuit 132 and plays these tracks repeatedly. If the storage volume of the cache memory 230 is large enough, the controller 220 is capable of utilizing the cache memory 230 to buffer (i.e. to store in this application) these tracks to be repeated so the data processing circuit 132 only needs to access the partial DVD image 116p through the network system 120 once. In addition, the controller 220 of the data processing circuit 132 is capable of utilizing the cache memory 230 to buffer at least a portion of the partial DVD image 116p through the network system 120 in advance to avoid network traffic jam.

Please note, according to a data distributing method of the present invention, the content of each track can be replaced repeatedly by the server 110 while the DVD player 130 plays the tracks repeatedly in sequence. Through the data distributing method, the DVD player 130 is capable of playing a long program by playing a few tracks, e.g. a first track and a second track. In order to emulate a normal DVD having a program length limitation, the long program usually needs to be divided into a plurality of portions. In this embodiment, the server 110 firstly sends a control script to emulate normal DVD control. When the server 110 provides a first portion and a second portion of an encoded audio/video data of the long program utilizing the first and second tracks, respectively, the DVD player 130 is capable of playing the first and second tracks to play the first portion and the second portion. After the DVD player 130 receives the first portion from the server 110, the server 110 replaces the first portion with a third portion of the encoded audio/video data to provide the third portion utilizing the first track. Similarly, after the DVD player 130 receives the second portion from the server 110, the server 110 replaces the second portion with a fourth portion of the encoded audio/video data to provide the fourth portion utilizing the second track. So the DVD player 130 plays the first track again to play the third portion and plays the second track again to play the fourth portion. In this way, the server 110 replaces the content of the first track repeatedly to provide the encoded audio/video data utilizing the first track while the DVD player 130 is playing or buffering the second track. In the same way, the server 110 replaces the content of the second track repeatedly to provide the encoded audio/video data utilizing the second track while the DVD player 130 is playing or buffering the first track. As a result, the DVD player 130 plays the first track, the second track, the first track, the second track . . . repeatedly in sequence to play the encoded audio/video data. Additionally, the server 110 replaces the content of the first track and the content of the second track repeatedly in sequence. In another example of the application mentioned above, only a single track is utilized to provide the encoded audio/video data. The server 110 replaces the content of a unit (e.g. a sector or multiple sectors) in the single track after the DVD player 130 receives the content of the unit. As a result, the DVD player 130 is capable of playing the single track repeatedly to play a program. As needed according to the DVD data format mentioned above, the server 110 may send a control script for repeat control to the DVD player 130 through the network system 120 so the DVD player 130 plays the track or tracks provided in the server 110 repeatedly.

According to the present invention, the audio/video disc player mentioned above can be coupled to the network system by either a direct cable connection or wireless communication. Please refer to FIG. 2 again. In another embodiment similar to the first embodiment, the network interface 210 is replaced with a wireless interface complying with at least one of the IEEE 802.11b standard, the IEEE 802.11a standard, and the IEEE 802.11g standard.

According to the present invention, the encoded audio/video data mentioned above can be stored in either a hard disc or a memory of the server. Please refer to FIG. 1 again. In another embodiment similar to the first embodiment, the hard disc 116 is replaced with a memory, in which the partial DVD image 116p is stored.

Although only a single DVD player 130 is illustrated in the first embodiment, this is not a limitation of the present invention. Those skilled in the art will understand that multiple audio/video disc player architectures can be applied to other data distributing systems similar to the data distributing system 100 according to different embodiments of the present invention. In addition, those skilled in the art will also understand that the data processing circuit 132 and the DVD decoder 134 can be integrated into a single module while the bus 130b can be either a single bus or split buses according to different embodiments of the present invention.

Furthermore, as long as the implementation of the present invention is not hindered, the communication protocol mentioned above can be other kinds of protocols such as an ATA protocol and variations thereof.

It is an advantage of the present invention that the present invention method and device can be implemented in the same form of consumer products that are widely used nowadays. As a result, the design effort and the production cost together with the installation cost of the receiving end devices for distributing multimedia content through a network system are greatly reduced.

It is an advantage of the present invention that through the present invention, the end users have no need to learn new operation commands or procedures as the data processing circuit is capable of emulating a DVD loader in the audio/video disc player. Therefore, training the end users to operate the audio/video disc player mentioned above and the data processing circuit thereof is unnecessary.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing circuit of an audio/video player, the audio/video player comprising a decoder capable of decoding data outputted from an optical storage device through a communication protocol, the data processing circuit comprising:
a first interface electrically coupled to a network system for receiving an encoded audio/video data from the network system; and
a second interface electrically coupled to the decoder and the first interface, the second interface emulating operations of the optical storage device and transmitting the encoded audio/video data to the decoder through the communication protocol.

2. The data processing circuit of claim 1 further comprising:
a controller electrically connected to the first and second interfaces for controlling data flow between the first interface and the second interface.

3. The data processing circuit of claim 2 further comprising:
a memory electrically connected to the controller for buffering the encoded audio/video data under the control of the controller.

4. The data processing circuit of claim 1, wherein the audio/video player is an audio/video disc player.

5. The data processing circuit of claim 4, wherein the audio/video player is a DVD player, the encoded audio/video data has a DVD data format, the decoder is a DVD decoder, and the data processing circuit emulates a DVD loader.

6. The data processing circuit of claim 5, wherein the encoded audio/video data includes at least a portion of an image file generated from a DVD.

7. The data processing circuit of claim 1, wherein the communication protocol is an ATA protocol or a variation thereof.

8. The data processing circuit of claim 7, wherein the communication protocol is an ATAPI protocol.

9. The data processing circuit of claim 1, wherein the first interface is an Ethernet interface.

10. The data processing circuit of claim 1, wherein the first interface complies with at least one of the IEEE 802.11b standard, the IEEE 802.11a standard, and the IEEE 802.11g standard.

11. The data processing circuit of claim 1, wherein the encoded audio/video data includes MPEG encoded sequences.

12. An audio/video player comprising:
a decoder capable of decoding data outputted from an optical storage device through a communication protocol; and
a data processing circuit comprising:
a first interface electrically coupled to a network system for receiving an encoded audio/video data from the network system; and
a second interface electrically coupled to the decoder and the first interface, the second interface emulating operations of the optical storage device and transmitting the encoded audio/video data to the decoder through the communication protocol.

13. The audio/video player of claim 12, wherein the data processing circuit further comprises:
a controller electrically connected to the first and second interfaces for controlling data flow between the first interface and the second interface.

14. The audio/video player of claim 13, wherein the data processing circuit further comprises:
a memory electrically connected to the controller for buffering the encoded audio/video data under the control of the controller.

15. The audio/video player of claim 12, wherein the audio/video player is an audio/video disc player.

16. The audio/video player of claim 15, wherein the audio/video player is a DVD player, the encoded audio/video data has a DVD data format, the decoder is a DVD decoder, and the data processing circuit emulates a DVD loader.

17. The audio/video player of claim 16, wherein the encoded audio/video data includes at least a portion of an image file generated from a DVD.

18. The audio/video player of claim 15, wherein the audio/video player is a DVD player, the decoder is a DVD decoder, the data processing circuit emulates a first DVD loader, and the DVD player further comprises:
a second DVD loader for loading a DVD to provide the decoder with data stored in the DVD.

19. The audio/video player of claim 12, wherein the communication protocol is an ATA protocol or a variation thereof.

20. The audio/video player of claim 19, wherein the communication protocol is an ATAPI protocol.

21. The audio/video player of claim 12, wherein the first interface is an Ethernet interface.

22. The audio/video player of claim 12, wherein the first interface complies with at least one of the IEEE 802.11b standard, the IEEE 802.11a standard, and the IEEE 802.11g standard.

23. The audio/video player of claim 12, wherein the encoded audio/video data includes MPEG encoded sequences.

24. A data processing method of an audio/video player, the audio/video player comprising a decoder capable of decoding data outputted from an optical storage device through a communication protocol, the data processing method comprising:
receiving an encoded audio/video data from a network system; and providing an interface, and utilizing the interface for emulating operations of the optical storage device and for transmitting the encoded audio/video data to the decoder through the communication protocol.

25. The data processing method of claim 24 further comprising:
buffering the encoded audio/video data.

26. The data processing method of claim 24, wherein the audio/video player is an audio/video disc player.

27. The data processing method of claim 26, wherein the audio/video player is a DVD player, the encoded audio/video data has a DVD data format, the decoder is a DVD decoder, and the interface emulates operations of a DVD loader.

28. The data processing method of claim 27, wherein the encoded audio/video data includes at least a portion of an image file generated from a DVD.

29. The data processing method of claim 24, wherein the communication protocol is an ATA protocol or a variation thereof.

30. The data processing method of claim 29, wherein the communication protocol is an ATAPI protocol.

31. The data processing method of claim 24, wherein the receiving step further comprises:
utilizing an Ethernet interface to receive the encoded audio/video data from the network system.

32. The data processing method of claim 24, wherein the receiving step further comprises:
receiving the encoded audio/video data from the network system according to at least one of the IEEE 802.11b standard, the IEEE 802.11a standard, and the IEEE 802.11g standard.

33. The data processing method of claim 24, wherein the encoded audio/video data includes MPEG encoded sequences.

34. A data distributing method comprising:
(a) providing a first portion of an encoded audio/video data utilizing a first track;
(b) playing the first track to play the first portion; and
(c) replacing the first portion with another portion of the encoded audio/video data to provide the encoded audio/video data utilizing the first track, and playing the first track to play the encoded audio/video data.

35. The data distributing method of claim 34, wherein step (a) further comprises providing a second portion of the encoded audio/video data utilizing a second track, step (b) further comprises playing the second track to play the second portion, and step (c) further comprises:
replacing the second portion with another portion of the encoded audio/video data to provide the encoded audio/video data utilizing the second track, and playing the second track to play the encoded audio/video data.

36. The data distributing method of claim 35, wherein step (c) further comprises:
replacing the content of the first track and the content of the second track repeatedly in sequence to provide the encoded audio/video data utilizing the first and second tracks, and playing the first and second tracks repeatedly in sequence to play the encoded audio/video data.

37. The data distributing method of claim 34, wherein step (c) further comprises:
replacing the content of the first track repeatedly to provide the encoded audio/video data utilizing the first track, and playing the first track repeatedly to play the encoded audio/video data.
